(19) United States
(12) Patent Application Publication
(10) Pub. No.: US 2010/0259451 A1
(43) Pub. Date: Oct. 14, 2010

(54) Digital Television Antenna

(75) Inventors: Yao-Yuan Chang, Taipei County (TW); Wen-Shyang Chen, Taipei County (TW); Tsung-Wen Chiu, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: Advanced Connectek Inc., Taipei County (TW)

(21) Appl. No.: 12/478,231

(22) Filed: Jun. 4, 2009

(30) Foreign Application Priority Data
Apr. 10, 2009 (TW) 098112032

(51) Int. Cl. H01Q 1/38

(52) U.S. Cl. 343/700 MS

(57) ABSTRACT

A digital television antenna comprises a baseplate having a first surface and a second surface; a radiation conductor arranged on the first surface and having a main portion and extension portions; a coupling conductor arranged on the second surface and corresponding to the radiation conductor, wherein a first conductor and a second conductor extend from one end of the coupling conductor and wriggle on the second surface; a short-circuit member, wherein one end of the short-circuit member is connected to another end of the coupling conductor; and a grounding plane connected to another end of the short-circuit member. The coupling of the radiation conductor, the coupling conductor, the first conductor and the second conductor provides the standard frequency bands of the digital TV, whereby the antenna volume is greatly reduced, wherefore the digital TV antenna of the present invention features both a wide bandwidth and a miniaturized size.

### BACKGROUND OF THE INVENTION

1. Field of the Invention

The present invention relates to a digital television antenna, particularly to a digital television antenna integrating the frequency bands of the VHF system (170-230 MHz) and the UHF system (470-870 MHz).

2. Description of the Related Art

Since the digital television (TV) was inaugurated, it has been incorporated into many products having a dynamic display system, including various portable electronic products, such notebook computers, personal digital assistants, mobile phones, watches and cameras. The design of the antenna is a key to the image quality of the digital TV.

Referring to FIG. 1A and FIG. 1B respectively a top view and a bottom view of a “Miniaturized Planar Antenna of Digital Television” disclosed in a U.S. Pat. No. 7,486,237. The prior-art antenna 10 comprises an insulation board 11, a metallic radiation member 12, a metallic grounding member 13 and a metallic parasitic member 14. The insulation board 11 has a first surface and a second surface. The metallic radiation member 12 is arranged on the first surface. The metallic grounding member 13 and the metallic parasitic member 14 are arranged on the second surface of the insulation board 11 and connected to each other. The metallic radiation member 12 has a serpentine portion 121. The metallic parasitic member 14 also has a serpentine portion 141 corresponding to the metallic radiation member 12. The metallic parasitic member 14 can increase the receiving bandwidth of the antenna and increase the signal transmission efficiency of the digital TV signals.

In the prior art, the metallic radiation member 12 and the metallic parasitic member 14 have to respectively use the serpentine portions 121 and 141 to undertake electric coupling and radiation signal transmission. Furthermore, a wider second end 143 is used to increase the area of the radiation conductor. However, the design increases the volume of the antenna and impairs the miniaturization of the antenna. Besides, the serpentine portions 121 and 141 are very lengthy and complicated, which results in instable signal transmission. In addition, although the metallic parasitic member 14 is arranged on the second surface to increase the bandwidth, the effect thereof is not as well as expected.

### SUMMARY OF THE INVENTION

One objective of the present invention is to provide a digital TV antenna, wherein the coupling of a radiation conductor and a coupling conductor provides the frequency band of the standard UHF system (470-870 MHz), and wherein a first conductor and a second conductor both extending from the coupling conductor provides the frequency band of the VHF system (170-230 MHz), whereby the digital TV antenna system of the present invention has high-performance transmission frequency bands.

Another objective of the present invention is to provide a digital TV antenna, wherein the radiation components are effectively integrated on the upper and lower surfaces of the baseplate, whereby is greatly reduced the complexity of the serpentine conductors, the layout space, the assembly difficulty, and the fabrication cost, and whereby is increased the stability and quality of signal transmission.

To achieve the abovementioned objectives, the present invention proposes a digital TV antenna, which comprises a baseplate, a radiation conductor, a coupling conductor, a short-circuit member, and a grounding plane. The baseplate has a first surface and a second surface. The radiation conductor is arranged on the first surface and has a main portion and extension portions. The coupling conductor is arranged on the second surface and corresponding to the radiation conductor. A first conductor and a second conductor extend from one end of the coupling conductor and wriggle on the second surface. The first conductor and the second conductor respectively have terminals. One end of the short-circuit member is connected to the other end of the coupling conductor, and the other end of the short-circuit member is connected to the grounding plane.

In the present invention, the radiation conductor and the corresponding coupling conductor form a capacitive first coupling member, which feeds the energy of high-frequency signals into the antenna. Appropriately adjusting the capacitance of the first coupling member can modulate the input impedance and greatly reduce the size of the antenna. The first conductor and the second conductor respectively extend from the coupling conductor and the radiation conductor form monopole antenna structure of a coupling-type feeding provides the frequency band of the standard UHF system (470-870 MHz) for the digital TV. Fine tuning the size and volume of the grounding member can improve the impedance matching of the UHF system. The terminals of the first conductor and the second conductor extend from the coupling conductor together with the extension portions of the radiation conductor form a second coupling member. The signal travels from the radiation conductor, through the coupling conductor, the first conductor, the second conductor, the second coupling member and the extension portions, and then back to the radiation conductor to form a loop antenna providing the frequency band of the VHF system (170-230 MHz). The capacitance of the second coupling member can be adjusted via varying the lengths and the terminal positions of the first and second conductors to improve the impedance matching of the VHF system, whereby is achieved the high-transmission bandwidth and the quality stability of the antenna system.

Below, the embodiments are described in detail to make easily understood the technical contents of the present invention.

### BRIEF DESCRIPTION OF THE DRAWINGS

FIG. 1A is a top view of a “Miniaturized Planar Antenna of Digital Television” disclosed in a U.S. Pat. No. 7,486,237;

FIG. 1B is a bottom view of a “Miniaturized Planar Antenna of Digital Television” disclosed in a U.S. Pat. No. 7,486,237;

FIG. 2 is a top view of a digital TV antenna according to a first embodiment of the present invention;

FIG. 3A is a top view of a first surface of a baseplate according to the first embodiment of the present invention;

FIG. 3B is a top view of a second surface of a baseplate according to the first embodiment of the present invention;

FIG. 4 is a top view of a digital TV antenna according to a second embodiment of the present invention; and

FIG. 5 is a diagram showing the measurement result of the return loss in the first embodiment.

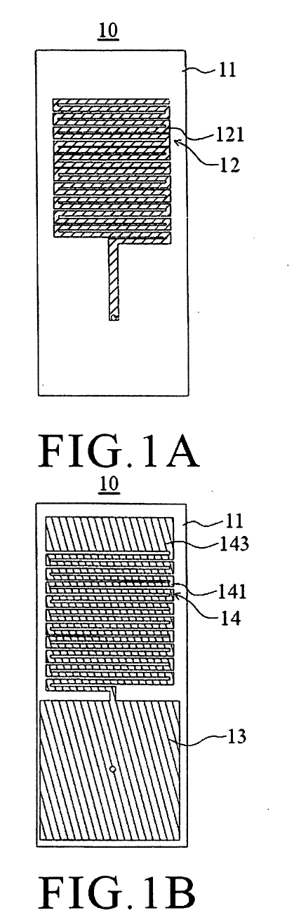

### DETAILED DESCRIPTION OF THE INVENTION

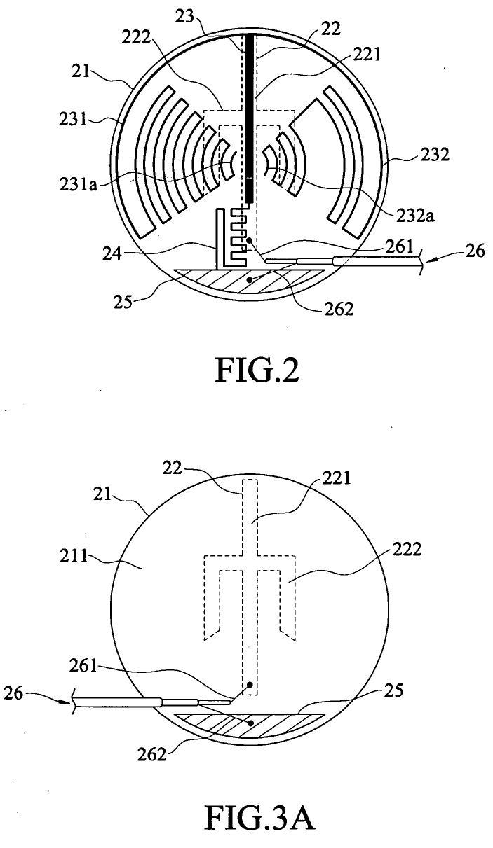

Referring to FIG. 2, a top view of a digital TV antenna according to a first embodiment of the present invention is shown. The digital TV antenna of the present invention comprises a baseplate 21, a radiation conductor 22, a coupling conductor 23, a short-circuit member 24 and a grounding plane 25. The baseplate 21 has a first surface 211 (not designated in the drawings) and a second surface 212 (not designated in the drawings). The radiation conductor 22 has a main portion 221 and extension portions 222. The coupling conductor 23 extends to form a first conductor 231 and a second conductor 232. The digital TV antenna of the present invention further comprises a feeder cable 26 including a central wire 261 connected to the radiation conductor 22 and an outer wire 262 connected to the grounding plane 25.

In the first embodiment, the baseplate 21 is a circular board having a first surface 211 and a second surface 212. The radiation conductor 22 is arranged on the first surface 211 of the baseplate 21 and has a main portion 221 and extension portions 222. The coupling conductor 23 is arranged on the second surface 212 and corresponding to the radiation conductor 22. One end of the coupling conductor 23 extends on the second surface 211 to form the first conductor 231 and the second conductor 232 both having a serpentine shape and respectively having a terminal 231a and a terminal 232a. The other end of the coupling conductor 23 is connected to one end of the short-circuit member 24. The other end of the short-circuit member 24 is connected to the grounding plane 25. The central wire 261 of the feeder cable 26 is connected to the radiation conductor 22 and transmits high-frequency signals to the radiation conductor 22. The outer wire 262 is connected to the grounding plane 25.

The baseplate 21 is a circular board having a diameter of about 73 mm and a circumference of about 229.22 mm. The main portion 221 of the radiation conductor 22 has a length of about 6 mm and a width of about 7 mm. Each extension portion 222 has an L-like shape, and the rectangle near the main portion 221 has a length of about 6 mm and a width of about 4 mm, and the trapezoid on the other side has an upper base of about 20 mm, a bottom base of about 22.5 mm, and a height of about 4 mm. The coupling conductor 23 has a long rectangle corresponding to the radiation conductor 22, and the long rectangle has a length of about 45 mm and a width of about 2 mm. The conduction path of the short-circuit member 24 has a length of about 52 mm.

In the first embodiment, the main portion 221 of the radiation conductor 22 and the coupling conductor 23 form a first coupling member where a first resonant mode of the antenna system is excited. The impedance matching of the first resonant mode can be improved via fine tuning the size and volume of the short-circuit member 24. The first conductor 231 and the second conductor 232 are used to excite a second resonant mode of the antenna system. The extension portions 222 of the radiation conductor 22 and the terminals 231a and 232a of the first and second conductors 231 and 232 form a second coupling member generating a capacitive coupling effect. The impedance matching of the second resonant mode can be improved via fine tuning the capacitance of the second coupling member.

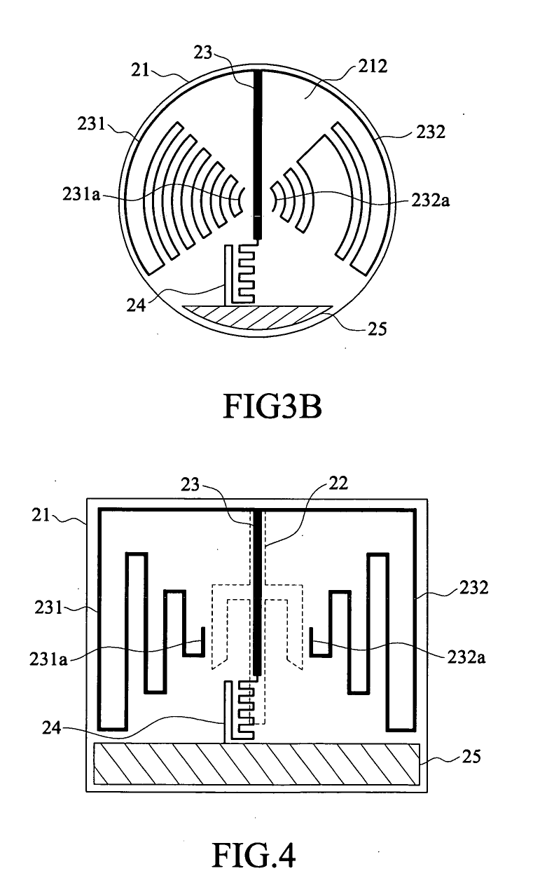

Referring to FIG. 3A, a top view of the first surface of the baseplate according to the first embodiment of the present invention is shown. The main portion 221 of the radiation conductor 22 has a straight-line shape. The extension portions 222 respectively protrude from two sides of the main portion 221 to form L-like shapes. The central wire 261 of the feeder cable 26 is connected to one terminal of the radiation conductor 22. The outer wire 262 of the feeder cable 26 is connected to the grounding plane 25 on the bottom of the first surface 211.

Referring to FIG. 3B, a top view of the second surface of the baseplate according to the first embodiment of the present invention is shown. The coupling conductor 23 is arranged on the second surface 212 and corresponding to the radiation conductor 22. Similar to the main portion 221 of the radiation conductor 22, the coupling conductor also has a straight-line shape. The first conductor 231 and the second conductor 232 respectively extend from two sides of the coupling conductor 23 and wriggle on the second surface 211. The first conductor 231 and the second conductor 232 respectively have a terminal 231a and a terminal 232a, which neighbor the coupling conductor 23 but do not physically contact the coupling conductor 23. The first conductor 231 and the second conductor 232 are respectively corresponding to the extension portions 222 of the radiation conductor 22. The first conductor 231, the second conductor 232 and the extension portions 222 generate a capacitive coupling effect. As the first conductor 231 and the second conductor 232 respectively wriggle from two opposite laterals of the coupling conductor 23 and have different lengths, they substantially generate two different modes. Thus is increased the transmission bandwidth of the antenna system.

Referring to FIG. 4, a top view of a digital TV antenna according to a second embodiment of the present invention is shown. The second embodiment is basically similar to the first embodiment, but the second embodiment has a rectangular baseplate. Therefore, the grounding plane also has a rectangular shape in the second embodiment. The first conductor 231 and the second conductor 232 respectively wriggling from two opposite laterals of the coupling conductor 23 also have about rectangular paths. In the present invention, no matter what shape the baseplate has, the conductors are disposed according to the principle disclosed in the present invention.

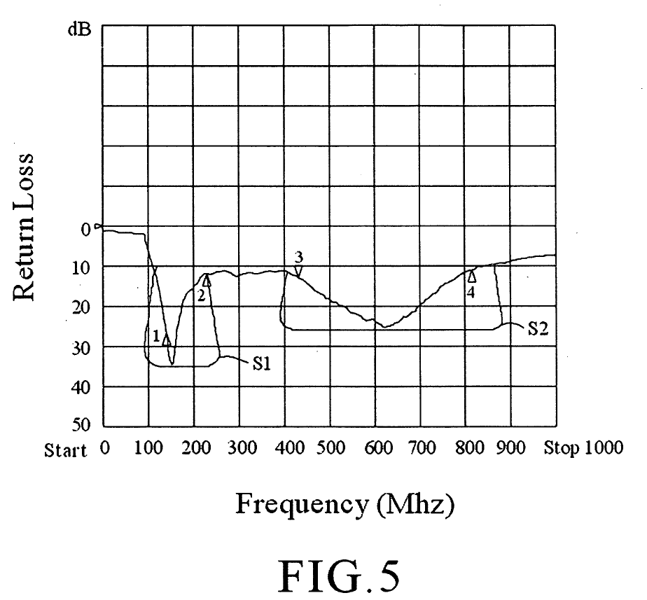

Referring to FIG. 5, a diagram showing the measurement result of the return loss in the first embodiment is shown, wherein the horizontal axis denotes frequencies, and the vertical axis denotes dB values. If the operation bandwidth of the antenna system is defined by the return loss greater than 10 dB, the bandwidth S1 ranges from 100 to 230 MHz and covers the frequency band of the VHF system. The bandwidth S2 ranges from 400 to 870 MHz and covers the frequency band of the UHF system. The measurement result proves that the present invention can achieve the required frequency bands.

The above description has proved that the present invention possesses utility, novelty and non-obviousness and meets the condition for a patent. However, the embodiments described above are only to exemplify the present invention but not to limit the scope of the present invention. Any equivalent modification or variation according to the spirit of the present invention is to be also included within the scope of the present invention.

What is claimed is:

1. A digital television antenna comprising
a baseplate having a first surface and a second surface;
a radiation conductor arranged on said first surface and having a main portion and extension portions;
a coupling conductor arranged on said second surface and corresponding to said radiation conductor, wherein a first conductor and a second conductor extend from one end of said coupling conductor and wriggle on said second surface, and said first conductor and said second conductor respectively have terminals;
a short-circuit member, wherein one end of said short-circuit member is connected to another end of said coupling conductor; and
a grounding plane connected to another end of said short-circuit member.

2. The digital television antenna according to claim 1, wherein said first surface of said baseplate has a feeder cable comprising
a central wire connected to said radiation conductor; and
an outer wire connected to said grounding plane.

3. The digital television antenna according to claim 1, wherein said baseplate has a circular shape or a rectangular shape.

4. The digital television antenna according to claim 1, wherein said main portion of said radiation conductor and said coupling conductor form a first coupling member.

5. The digital television antenna according to claim 1, wherein said extension portions of said radiation conductor and said terminals of said first conductor and said second conductor form a second coupling member.

6. The digital television antenna according to claim 1, wherein said terminals of said first conductor and said second conductor neighbor said coupling conductor but do not physically contact said coupling conductor.

7. The digital television antenna according to claim 1, wherein said first conductor and said second conductor are respectively arranged on two opposite laterals of said coupling conductor.

8. The digital television antenna according to claim 1, wherein said first conductor and said second conductor respectively have different lengths.
